(19) United States
(12) Patent Application Publication
(10) Pub. No.: US 2009/0287959 A1
(43) Pub. Date: Nov. 19, 2009

(54) SYSTEM AND METHOD FOR TESTING COMPUTER

(75) Inventor: Yong-An Wang, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Taipei Hsien (TW)

(21) Appl. No.: 12/200,455

(22) Filed: Aug. 28, 2008

(30) Foreign Application Priority Data
May 16, 2008 (CN) 200810301614.8

(51) Int. Cl. G06F 11/273; G06F 11/34

(52) U.S. Cl. 714/30; 714/45; 714/E11.17; 714/E11.189

(57) ABSTRACT

A test system includes at least one computer and a control circuit for testing the computer. The computer includes an input interface and an output interface. The control circuit is configured for sending test signals to the input interface and receiving feedback signals from the output interface for facilitating locating and recording errors during testing of the computer. A testing method for testing the computer is also disclosed.

### BACKGROUND

1. Technical Field

The present invention relates to a system and method for testing computers.

2. Description of Related Art

After a computer is produced, stability tests are required. A conventional test fashion is manually operating the computer repeatedly to check whether the computer can pass stability test. However, because a great number of computers need to be tested in the manufacturing process, manually testing the computer is inefficient and a waste of manpower.

An improved method for automatically testing the computer is also adopted. The method includes steps of utilizing a microcontroller (MCU) with test procedure burnt therein to send test signals to the computer and detecting whether the computer can pass POST (Power On Self Test), whether the computer can be awaked normally etc. However, there is no feedback signal from the computer to the MCU. The test signals cannot be adjusted automatically according to actual running conditions of the computer. Error test information is not available to be recorded.

What is needed, therefore, is a system and method for testing computers capable of bi-directionally communicating with a control chip of the system.

### BRIEF DESCRIPTION OF THE DRAWINGS

FIG. 1 is a block diagram of an embodiment of a test system, the test system including a control circuit and a computer;

FIG. 2 illustrates a detailed block diagram of the test system of FIG. 1; and

FIG. 3 is a flow chart of an embodiment of a test method for testing a computer.

### DETAILED DESCRIPTION

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

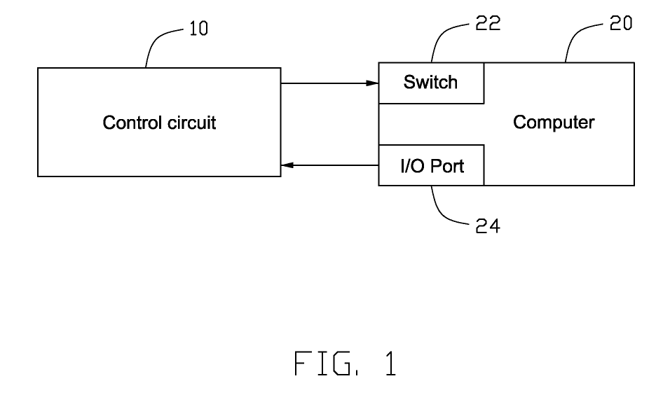

Referring to FIG. 1, an embodiment of a test system includes a computer 20 and a control circuit 10 configured for testing the computer 20. The computer 20 includes a switch 22 and an input/output (I/O) port 24. The switch 22 is connected to the control circuit 10 and configured for receiving test signals from the control circuit 10. The I/O port 24 is connected to the control circuit 10 and configured for sending out feedback information to the control circuit 10.

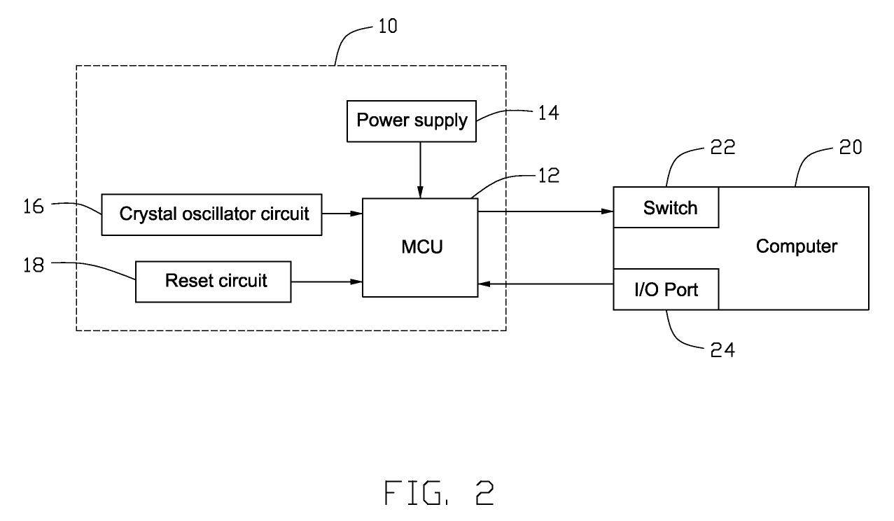

Referring to FIG. 2, the control circuit 10 includes a microcontroller (MCU) 12, a power supply 14 configured for powering the MCU 12, a crystal oscillator circuit 16 connected to the MCU 12 and configured for applying clock signals to the MCU 12, and a reset circuit 18 connected to the MCU 12 and configured for applying reset signals to the MCU 12. In one embodiment, a test procedure may be burnt into the MCU 12 for testing the computer 20. An output of the MCU 12 is connected to the switch 22 to send test signals to the computer 20 according to the test procedure. An input of the MCU 12 is connected to the I/O port 24 to receive feedback signals from the computer 20. In one embodiment, an address of the I/O port 24 may be a port number to which test codes are written during testing of the computer 20, for example, port 80H.

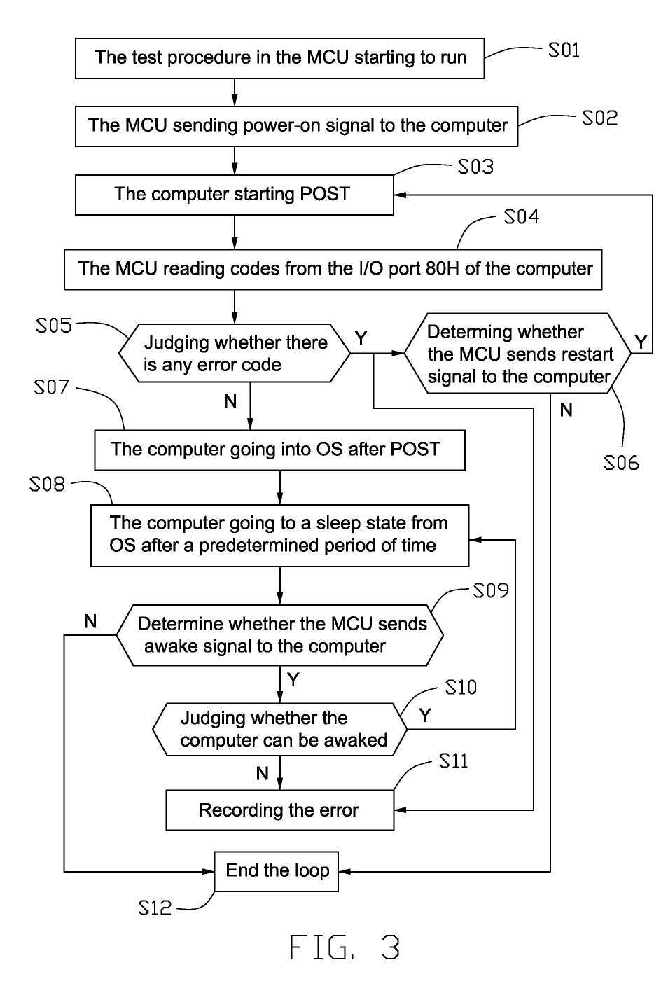

Referring to FIG. 3, is a flowchart utilizing the above described test system for testing the computer 20. Depending on the embodiment, certain of the steps described below may be removed, others may be added, and the sequence of steps may be altered.

In a block S01, the test procedure may be started in the MCU 12. Continuing to a block S02, the MCU 12 sends a power-on signal to the computer 20. Moving to a block S03, the computer 20 starts power on self test (POST) codes and sends the POST codes to the I/O port. Continuing to a step S04, the MCU 12 reads the codes sent from the I/O port.

In a decision step S05, the MCU 12 determines if there are any error codes. If there are error codes, for example, a code 26H indicating that the super I/O failed during POST, the method continues to a decision step S06. If there is no error code read by the MCU 12, the method continues to a step S07.

In the decision step S06, the MCU 12 determines if a restart signal is to be sent to the computer 20. If a restart signal needs to be sent, then the method continues back to the step S03 and executes a loop of S03→S04→S05→S06 for locating the error and gathering more detailed information regarding the error. The error information is recorded in a step S11. If a number of iterations of the loop equals a predetermined number according to the test procedure, the MCU 12 stops sending the restart signal to the computer 20, the loop ends, and the method is continues to a step S12.

Moving to the step S07, the computer 20 goes into an operation system (OS) after POST. Continuing to a step S08, the computer 20 goes into a sleep state from the OS after a predetermined period of time.

In a decision step S09, the MCU 12 determines if an awake signal is sent to the switch 22 to test an awake function of the computer 20. If the awake signal is sent to the computer, the method continues to a decision step S10. If the awake signal is not sent to the computer, the method continues to the step S12.

Moving to the decision step S10, the MCU 12 reads codes from the I/O port 24 and determines if the computer 20 can be awaked In one particular embodiment, if the MCU 12 reads a code of 30h , which indicates that the computer 20 has been awaked, the method continues back to the step S08 and executes a loop of S08→S09→S10 for repeating a testing stability of the awake function. If the number of iterations equals a predetermined number according to the test procedure, the MCU 12 stops sending the awake signal to the computer 20 and the method continues to the step S12. In another particular embodiment, if the MCU 12 reads a code of D3H, which indicates that the computer 20 cannot be awaked normally, the method continues to the step S11 to record the error.

Moving to the step S11, the MCU 12 records the error.

In the step S12, the test ends and a further check for the computer 20 may be made.

It may be appreciated that more than one computer 20 may be tested by the control circuit 10. It may also be appreciated that the control circuit 10 may include another type of programmable chip instead of the MCU 12.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A test system comprising:
at least one computer comprising an input interface and an output interface; and
a control circuit connected to the at least one computer and configured for sending test signals to the input interface and receiving feedback signals from the output interface.

2. The test system of claim 1, wherein the input interface is a switch interface configured for receiving restart signals or awake signals from the control circuit.

3. The test system of claim 2, wherein the output interface is an input/output (I/O) port configured for sending out feedback information to the control circuit and from which the control circuit reads codes during testing.

4. The test system of claim 1, wherein an address of the I/O port is 80H.

5. The test system of claim 1, wherein the control circuit comprises a programmable chip with a test procedure programmed in the programmable chip configured for testing the computer.

6. The test system of claim 5, wherein the programmable chip is a microcontroller.

7. The test system of claim 6, wherein the control circuit further comprises a crystal oscillator circuit connected to the microcontroller and a reset circuit connected to the microcontroller.

8. A test method for testing a computer, comprising:
sending test signals to the computer;
reading codes from the computer to determine whether the computer passes each test process; and
locating the error to obtain detailed error information and recording the error information, if there is any error code.

9. The test method of claim 8, wherein the test signals comprise a start signal to power on the computer.

10. The test method of claim 9, wherein reading codes from the computer comprises reading Power On Self Test codes from the computer.

11. The test method of claim 10, wherein locating the error comprises executing a first loop to get detailed error information if there is any error code during Power On Self Test.

12. The test method of claim 11, wherein the first loop comprises sending a restart signal to the computer after reading error code during Power On Self Test.

13. The test method of claim 12, wherein the first loop repeats to send the restart signal to the computer within a predetermined number of times.

14. The test method of claim 13, further comprising awaking the computer if the computer passes the Power On Self Test and goes into a sleep state.

15. The test method of claim 14, wherein reading codes from the computer further comprises reading codes indicating whether the computer can be normally awaked.

16. The test method of claim 15, further comprising executing a second loop to repeatedly—test an awake function of the computer.

17. The test method of claim 16, wherein the second loop comprises sending an awake signal to the computer after the computer goes into the sleep state.

18. The test method of claim 17, wherein the second loop repeats to send the awake signal within another predetermined number of times.
